(19) United States
(12) Patent Application Publication
(10) Pub. No.: US 2026/0331493 A1
(43) Pub. Date: Oct. 22, 2026

(54) COMPOSITION FOR LITHIUM-ION BATTERY CATHODE

(71) Applicant: Kemira Oyj, Helsinki (FI)

(72) Inventors: Tapio HONKANEN, Helsinki (FI); Salla PUUPPONEN, Helsinki (FI); Tatjana KARPOVA, Helsinki (FI); Anneli LEPO, Helsinki (FI)

(21) Appl. No.: 19/486,410

(22) PCT Filed: May 15, 2024
(86) PCT No.: PCT/FI2024/050232

§ 371 Date: Nov. 21, 2025

(30) Foreign Application Priority Data
May 24, 2023 (FI) 20235577

(51) Int. Cl. H01M 4/58; H01M 4/02; H01M 4/04; H01M 4/136; H01M 4/62; H01M 4/66; H01M 10/0525

(52) U.S. Cl. CPC H01M 4/5825; H01M 4/0404; H01M 4/136; H01M 4/622; H01M 4/625; H01M 4/661; H01M 4/663; H01M 4/667; H01M 10/0525; H01M 2004/028

(57) ABSTRACT

There is provided a composition for lithium-ion battery cathode and a method for producing the composition. There is also provided an electrode comprising an active material layer formed from the composition on a current collector.

### TECHNICAL FIELD

The present disclosure generally relates to a lithium-ion battery cathode composition. The disclosure relates particularly, though not exclusively, to a lithium-ion battery cathode composition comprising at least one cathode active material, at least one electrical conductivity enhancing additive, at least one viscosity modifier and at least one water-insoluble binder. The disclosure additionally relates to an electrode for a lithium-ion battery comprising a current collector and active material layer formed from the composition on the collector.

### BACKGROUND

This section illustrates useful background information without admission of any technique described herein representative of the state of the art.

Lithium ion battery (LiB) cathodes usually consist of active material (e.g. lithium nickel manganese cobalt oxides (NMC) or lithium ferro phosphate (LFP, LiFePO4), electrical conductivity enhancing additive (e.g. carbon nanotube, graphene, or carbon black) and binder, which binds the electrode components together and to the aluminum current collector.

Currently, polyvinylidene fluoride (PVDF) is the well-established cathode binder in LiBs. PVDF is thermally stable and chemically inert over the used potential range. However, halogenated PVDF requires environmentally harmful organic N-methylpyrrolidone (NMP) solvent and is reactive towards lithiated graphite.

Due to these disadvantages, other binder chemistries have been researched for PVDF replacement. Polyacrylic acids (PAA) have been identified as potential binders for LiB electrodes. PAA can be in acidic form, or it can be partly or completely neutralized e.g. with sodium, lithium or potassium.

However, there is stil a need for novel and improved lithium-ion battery cathode compositions.

### SUMMARY

In a first aspect the present invention provides a lithium-ion battery cathode composition comprising at least one cathode active material, at least one electrical conductivity enhancing additive, at least one viscosity modifier and at least one water-insoluble binder.

In a second aspect the present invention provides an electrode for a lithium-ion battery comprising an aluminum current collector and at least one active material layer on at least one surface of the aluminum current collector, wherein the at least one active material layer is formed from the cathode composition according to the present invention.

In a third aspect the present invention provides a method for producing a lithium-ion battery cathode composition, wherein the method comprises mixing water and at least one viscosity modifier; followed by adding at least one electrical conductivity enhancing additive; followed by adding at least one cathode active material; and adding at least one water-insoluble binder.

In a fourth aspect the present invention provides a method for producing an electrode for a lithium-ion battery cathode, wherein the method comprises mixing water and at least one viscosity modifier; followed by adding at least one electrical conductivity enhancing additive; followed by adding at least one cathode active material; followed by adding at least one water-insoluble binder; followed by coating an aluminum current collector with the composition and drying the coated aluminum current collector.

In a fifth aspect the present invention provides a lithium-ion battery comprising the electrode for a lithium-ion battery according to the present invention.

In a sixth aspect the present invention provide use of the lithium-ion battery cathode composition according to the present invention for an electrode for a lithium-ion battery.

It was surprisingly found that a lithium-ion battery cathode composition comprising at least one cathode active material, at least one electrical conductivity enhancing additive, at least one viscosity modifier and at least one water-insoluble binder, such as an acrylic copolymer, provide excellent flexibility and adhesion to an aluminum current collector.

It was also found that by using poly(styrene acrylate), such as butylacrylate-styrene copolymer, as the water-insoluble binder having high solids content provide fast film-forming at drying and the small particle size of the dispersion ensures uniform distribution of the binder in the composition. By the selection of the ratio of styrene and acrylate, such as butyl acrylate in the composition, the hydrophobicity, flexibility and strength of the film can be adjusted.

It was also surprisingly found that half-cells (LFP/lithium metal) comprising the composition of the present invention are very stable.

The appended claims define the scope of protection.

### BRIEF DESCRIPTION OF THE FIGURES

FIG. 1 shows specific discharge capacity (mAh/g) of LFP electrodes done using water based binders (samples according to the present invention and references).

### DETAILED DESCRIPTION

In a first aspect the present invention provides a lithium-ion battery cathode composition comprising at least one cathode active material, at least one electrical conductivity enhancing additive, at least one viscosity modifier and at least one water-insoluble binder.

In one embodiment the cathode active material comprises lithium nickel manganese cobalt oxides (NMC LiNixMnyCozO2), lithium ferro phosphate (LFP, LiFePO4), carbon coated LFP, lithium cobalt oxide (LCO, LiCoO2), lithium manganese oxide (LMO, LiMn2O4), lithium nickel cobalt aluminum oxide (LiNiCoAlO2), lithium titanate (LTO, Li2TiO3) or a mixture thereof, preferably lithium ferro phosphate (LFP, LiFePO4), carbon coated LFP or a mixture thereof. In one embodiment amount of the cathode active material is 70-95 wt. %, preferably 80-95 wt. %, based on total dry weight of the composition. In one embodiment the electrical conductivity enhancing additive comprises carbon nanotube, graphene, carbon black, activated carbon or a mixture thereof.

In one embodiment amount of the electrical conductivity enhancing additive is 1-15 wt. %, preferably 2-10 wt. %, more preferably 2-5 wt. %, based on total dry weight of the composition.

In one embodiment the viscosity modifier comprises carboxy methyl cellulose (CMC), water soluble polysaccharides, water soluble anionic polysaccharides, poly vinyl alcohols, water soluble acrylic polymers or a mixture thereof, preferably the viscosity modifier is CMC. The viscosity modifier is used in the composition to increase or decrease the viscosity of the composition. The amount of the viscosity modifier in the composition is selected so that the composition has predetermined viscosity.

In one embodiment the amount of the viscosity modifier is 0.1-1.5 wt. %, preferably 0.5-1.5 wt. %, more preferably 0.5-1 wt. %, based on total dry weight of the composition.

In one embodiment the water-insoluble binder is in form of water based dispersion (i.e. water-insoluble binder dispersion, or water-based binder), preferably essentially free of organic solvents, preferably free of organic solvents.

In one embodiment the composition is water based composition.

In one embodiment the composition is essentially free of organic solvents, preferably free of organic solvents.

In one embodiment the water-insoluble binder is polymerized with combinations of monomers selected from alkyl acrylates, alkyl methacrylates and/or styrene that is optionally substituted. The monomers may include also water-soluble monomers, such as (meth)acrylic acid, in a small ratio.

The monomers and ratio of the monomers can be selected so that the composition has under process conditions such film forming temperature and glass transition temperature that flexibility of the film is obtained and maintained.

In one embodiment the water-insoluble binder is formed by polymerizing monomers selected from alkyl acrylates, alkyl methacrylates and/or styrene that is optionally substituted, water-soluble monomers, such as (meth)acrylic acid and a combination thereof.

In one embodiment the water-insoluble binder is selected from acrylic copolymers, preferably poly(styrene acrylate), more preferably butylacrylate-styrene copolymer. In one embodiment the water-insoluble binder dispersion comprises stabilizer.

In one embodiment the stabilizer is polymeric stabilizer or surfactant. The stabilizer is anionic, cationic and/or nonionic. Amount of the stabilizer is preferably <15 wt % of the dry content of the water-insoluble binder dispersion, more preferably <5 wt %, even more preferably <2.5 wt %.

In one embodiment the stabilizer comprises anionic surfactant.

In one embodiment amount of the water-insoluble binder is 1-15 wt. %, preferably 2-8 wt. %, more preferably 2-5 wt. %, based on total dry weight of the composition.

In one embodiment the water-insoluble binder has high solids content, preferably the solids content is 20-65, preferably, 35-60, more preferably 46-59. The high solids content provides fast film-forming at drying.

In one embodiment the water-insoluble binder has small particle size. The small particle size ensures uniform distribution of the water-insoluble binder in the composition.

In one embodiment particle size D50 for the polymer particles of the water-insoluble binder dispersion is in a range of 20-400 nm, preferably 40-300 nm, more preferably 50-200 nm, even more preferably 55-180 nm.

In one embodiment particle size D90 for the polymer particles of the water-insoluble binder dispersion is in a range of 50-500 nm, preferably 70-400 nm, more preferably 80-300 nm, even more preferably 90-280 nm.

All the particle sizes are measured by using Zetasizer Nano ZS, Malvern. In the present context the particle size D50 refers to the value for 50th percentile of a volume based distribution and the particle size D90 refers to the value for 90th percentile of a volume based distribution.

In a second aspect the present invention provides an electrode for a lithium-ion battery comprising an aluminum current collector and at least one active material layer on at least one surface of the aluminum current collector, wherein the at least one active material layer is formed from the cathode composition according to the present invention.

In one embodiment the aluminum current collector is carbon coated aluminum current collector.

In a third aspect the present invention provides a method for producing a lithium-ion battery cathode composition, wherein the method comprises the following steps
(i) mixing water and at least one viscosity modifier;
(ii) adding at least one electrical conductivity enhancing additive;
(iii) adding at least one cathode active material; and
(iv) adding at least one water-insoluble binder.

In one embodiment the viscosity modifier, the electrical conductivity enhancing additive, the cathode active material and the water-insoluble binder are preferably added sequentially in the order of the steps (i), (ii), (iii) and (iv). In one embodiment after each addition of a component the formed mixture is mixed.

The viscosity modifier, the electrical conductivity enhancing additive, the cathode active material and the water-insoluble binder may also be added in any other order, or two or more components may be added at the same time.

In one embodiment first water and at least one viscosity modifier are mixed; followed by adding at least one water-insoluble binder; followed by adding at least one electrical conductivity enhancing additive; followed adding at least one cathode active material.

In one embodiment the viscosity modifier, the electrical conductivity enhancing additive, the cathode active material and the water-insoluble binder are the same as defined above.

In a preferred embodiment, the method of the present invention produces the lithium-ion battery cathode composition according to the present invention.

In a fourth aspect the present invention provides a method for producing an electrode for a lithium-ion battery cathode, wherein the method comprises the following steps
(i) mixing water and at least one viscosity modifier;
(ii) adding at least one electrical conductivity enhancing additive;
(iii) adding at least one cathode active material;
(iv) adding at least one water-insoluble binder;
(v) coating an aluminum current collector with the composition; and
(vi) drying the coated aluminum current collector.

In one embodiment the viscosity modifier, the electrical conductivity enhancing additive, the cathode active material and the water-insoluble binder are preferably added sequentially in the order of the steps (i), (ii), (iii) and (iv). In one embodiment after each addition of a component the formed mixture is mixed.

The viscosity modifier, the electrical conductivity enhancing additive, the cathode active material and the water-insoluble binder may also be added in any other order, or two or more components may be added at the same time.

In one embodiment first water and at least one viscosity modifier are mixed; followed by adding at least one water-insoluble binder; followed by adding at least one electrical conductivity enhancing additive; followed adding at least one cathode active material.

In one embodiment the viscosity modifier, the electrical conductivity enhancing additive, the cathode active material and the water-insoluble binder are the same as defined above. In one embodiment the aluminum current collector is carbon coated aluminum current collector.

The coating of the aluminum current collector can be performed by any suitable method known for a skilled person. Such methods for example are slot-die, blade, roll-to-roll and gravure coating technologies.

The drying of the coated aluminum current collector can be performed by any suitable method known for a skilled person. Such methods for example are industrial dryer, oven drying and vacuum drying.

In a preferred embodiment, the method of the present invention produces the electrode for lithium-ion battery cathode according the present invention.

In a fifth aspect the present invention provides a lithium-ion battery comprising the electrode for a lithium-ion battery according to the present invention In a sixth aspect the present invention provide use of the lithium-ion battery cathode composition according to the present invention for an electrode for a lithium-ion battery.

### EXAMPLES

### Materials

Cathode active material: Carbon coated LFP

Conductive additive: Carbon black

Viscosity modifier: CMC

Reference binders: Water based binder and NMP

Binder in the composition of the present invention: Copolymer of butylacrylate-styrene

### Method According to the Present Invention for Producing Lithium-Ion Battery Composition

The electrode compositions were prepared by first mixing CMC and deionized water followed by addition conductive additive. Next cathode active material was added to the mixture followed by addition an aqueous binder dispersion. Amount of the conductive additive was 2 wt-%, and total amount of the CMC and the aqueous binder was 3.5 wt-% (percentages based on LFP weight e.g., amount of LFP is 100 wt-%). The components were mixed by using dispergator (IKA Ultra-Turrax T-25 digital) at speed 4000 rpm. The final solid content of the compositions was between 37 wt-% and 58 wt-%, depending on the used binder.

### Coating of Aluminum Current Collector

The prepared compositions were coated on carbon precoated aluminum foil with an automatic film applicator (BYK) and a film casting blade (Mitutoyo). Depending on the solid content of the slurry, wet thicknesses 225-275 μm were used to achieve 2 mAh/cm2 capacity loading and 12.5 mg/cm2 active mass loading. After casting, the aqueous coatings were dried in the oven at 60 °C for approximately 20 minutes. The electrodes were cut with an EL-Cell cutter (18 mm diameter) and pressed/calendared with 1.2 t/cm2 using a hydraulic press (Specac Atlas 25t manual hydraulic press).

### Electrochemical Performance

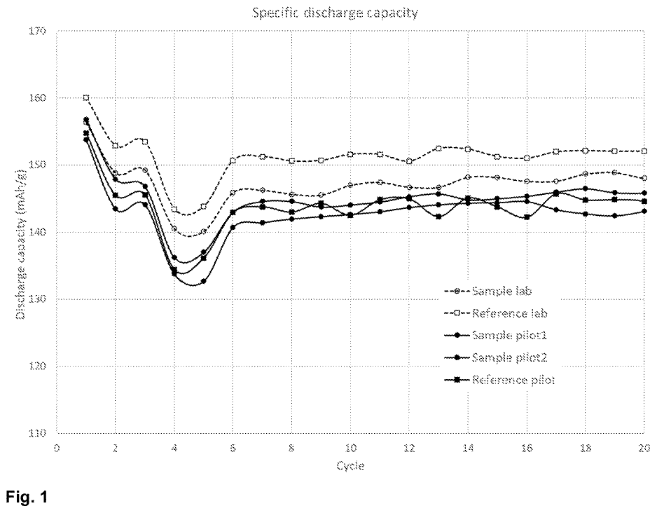

Half-cells were built using EL-cells to evaluate the stability of the cells. FIG. 1 shows the discharge capacities of LiB half-cells comprising the aluminum current collector coated with the composition of the present invention or reference compositions. In the FIG. 1 dotted line denotes laboratory coating and solid line denotes pilot coating. Half-cell comprising the aluminum current collector coated with the composition of the present invention is very stable, cycling 100-200 cycles.

Various embodiments have been presented. It should be appreciated that in this document, words comprise, include, and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A lithium-ion battery cathode composition comprising at least one cathode active material, at least one electrical conductivity enhancing additive, at least one viscosity modifier and at least one water-insoluble binder.

2. The composition according to claim 1, wherein the cathode active material comprises lithium nickel manganese cobalt oxides (NMC LiNixMnyCozO2), lithium ferro phosphate (LFP, LiFePO4), carbon coated LFP, lithium cobalt oxide (LCO, LiCoO2), lithium manganese oxide (LMO, LiMn2O4), lithium nickel cobalt aluminum oxide (LiNiCoAlO2), lithium titanate (LTO, Li2TiO3) or a mixture thereof.

3. The composition according to claim 1, wherein electrical conductivity enhancing additive comprises carbon nanotube, graphene, carbon black, activated carbon or a mixture thereof.

4. The composition according to claim 1, wherein the viscosity modifier comprises carboxy methyl cellulose (CMC), water soluble polysaccharides, water soluble anionic polysaccharides, polyvinyl alcohols, water soluble acrylic polymers or a mixture thereof.

5. The composition according to claim 1, wherein the water-insoluble binder is formed by polymerizing monomers selected from alkyl acrylates, alkyl methacrylates and/or styrene that is optionally substituted, water-soluble monomers, such as (meth)acrylic acid, and a combination thereof.

6. The composition according to claim 1, wherein amount of the cathode active material is 70-95 wt. % based on total dry weight of the composition.

7. The composition according to claim 1, wherein amount of the electrical conductivity enhancing additive is 1-15 wt. % based on total dry weight of the composition.

8. The composition according to claim 1, wherein amount of the viscosity modifier is 0.1-1.5 wt. %, based on total dry weight of the composition.

9. The composition according to claim 1, wherein amount of the water-insoluble binder is 1-15 wt. %, based on total dry weight of the composition.

10. An electrode for a lithium-ion battery comprising an aluminum current collector and at least one active material layer on at least one surface of the aluminum current collector, wherein the at least one active material layer is formed from the lithium-ion battery cathode composition according to claim 1.

11. The electrode according to claim 10, wherein the aluminum current collector is carbon coated aluminum current collector.

12. A method for producing a lithium-ion battery cathode composition comprising
(i) mixing water and at least one viscosity modifier;
(ii) adding at least one electrical conductivity enhancing additive;
(iii) adding at least one cathode active material; and
(iv) adding at least one water-insoluble binder.

13. A method for producing an electrode for a lithium-ion battery cathode comprising
(i) mixing water and at least one viscosity modifier;
(ii) adding at least one electrical conductivity enhancing additive;
(iii) adding at least one cathode active material;
(iv) adding at least one water-insoluble binder;
(v) coating an aluminum current collector with the composition; and
(vi) drying the coated aluminum current collector.

14. A lithium-ion battery comprising the electrode for a lithium-ion battery according to claim 10.

15. (canceled)

16. The composition according to claim 1, wherein amount of the cathode active material is 80-95 wt. % based on total dry weight of the composition

17. The composition according to claim 1, wherein amount of the electrical conductivity enhancing additive is 2-10 wt. % based on total dry weight of the composition.

18. The composition according to claim 1, wherein amount of the viscosity modifier is 0.5-1.5 wt. % based on total dry weight of the composition.

19. The composition according to claim 1, wherein amount of the water-insoluble binder is 2-8 wt. %, based on total dry weight of the composition.

20. The composition according to claim 1, wherein the cathode active material comprises lithium ferro phosphate (LFP, LiFePO4), carbon coated LFP or a mixture thereof.

21. The composition according to claim 1, wherein the viscosity modifier is CMC.
